(19) United States
(12) Patent Application Publication
(10) Pub. No.: US 2014/0352552 A1
(43) Pub. Date: Dec. 4, 2014

(54) BAKING DEVICE FOR BAUMKUCHEN

(71) Applicant: Arnold Pier, Heinsberg (DE)

(72) Inventor: Arnold Pier, Heinsberg (DE)

(21) Appl. No.: 14/363,501

(22) PCT Filed: Dec. 7, 2012
(86) PCT No.: PCT/EP2012/074816

§ 371 Date: Jun. 6, 2014

(30) Foreign Application Priority Data
Dec. 7, 2011 (DE) 11192445.2

(51) Int. Cl. A21B 5/04

(52) U.S. Cl. CPC A21B 5/04
USPC 99/341; 99/353

(57) ABSTRACT

The invention relates to a baking device for Baumkuchen for domestic use, comprising a housing that encloses a baking chamber, a heating apparatus in the baking chamber, a dough roller that can be pivoted relative to the heating apparatus in the baking chamber, which dough roller is supported in a replaceable manner between the free ends of two pivot arms and can be pivoted about a pivot axis supported in the housing for the pivot arms, wherein the dough roller can be rotationally driven. In the baking device according to the invention, the pivot axis is designed as a first drive shaft for pivoting the dough roller and the pivot arms are arranged inside the baking chamber.

The invention relates to a baking device for Baumkuchen as defined in the pre-characterizing part of claim 1, 4 or 7, respectively.

Devices form making Baumkuchen are known which have a rotary, exchangeable dough take-up roller and heat sources for baking the dough applied onto the roller in a housing in which the dough take-up roller can be pivoted from the dough take-up site to the heat source and back. The dough take-up site is formed by a dough pan. When the dough take-up roller is positioned above this pan, a ladle is used to pour dough onto the dough take-up roller slowly rotating around itself, until a continuous dough layer has formed on the roller. The excess dough drips back into the pan. The roller is then pivoted towards the heat source. The top lid of the machine is closed. After one to two minutes, the respective dough applied has been baked by the heat from the heat source. The lid is opened and the roller is pivoted forward to above the dough pan and new dough is poured on. This process is continued until the Baumkuchen has the desired thickness and is baked.

From DE-C-397520, a baking device for Baumkuchen is known, having a dough roller adjustable with respect to a heat source, the dough roller being supported in pivotable levers in both sides of the baking housing. The pivot levers can be locked in different positions. At one of their ends, a hand crank is provided for driving the dough roller, the crank being situated outside the interior of the baking chamber or can be replaced with a motor drive.

A drawback is that dough has to be applied manually on the dough roller in the position remote from the heat source, whereby the baking device is soiled to a considerable extent.

For this purpose, it is known from DE-C-572816 to provide a dripping pan into which dough can drip when dough is applied onto the conical dough rollers.

The known baking device has a drive shaft for the motorized drive of the dough roller, which passes through the housing. The drive shaft is guided in the side walls of the baking device in a slot-shaped guide, with pivot arms being arranged outside the housing of the baking device, the arms allowing the dough rollers to be pivoted outward to remove the cake.

It is a drawback in both DE-C-397520 and DE-C-572816 that lateral slots are pro-vided in the housing for the passage of the drive shaft of the dough roller and that the motor drive is installed on the drive shaft of the dough roller on the outside of the machine. The slots necessary in the housing cause a loss of energy and pose a risk of burns. Further, it is also possible that dirt gets into the baking chamber interior through the slots.

Therefore, it is an object of the present invention to provide a baking device of the type mentioned above, intended for domestic use, which has a compact structure and can be operated in an energy-saving and hygienic manner.

In order to achieve the object, the invention provides that on at least one side of the housing, a second drive shaft for the rotary drive of the dough roller is supported coaxially relative to the pivot axis.

Owing to the arrangement of two mutually coaxial drive shafts, a compact and energy-saving structure becomes possible, whereby a Baumkuchen baking device for domestic use can be provided.

The coaxial passage of the drive shafts through the housing avoids openings in the baking chamber that cause energy loss, may lead to non uniform baking results and present a risk of burns and/or a source of contamination.

Preferably, the second drive shaft is supported on the first drive shaft.

In an advantageous development it is provided that the housing has an integrated dough pan, the dough roller being pivotable from a heat-up and baking position near the heating device to a dough take-up position above a dough pan. Preferably, the dough roller can dip into the dough while rotating. For this purpose, it is merely necessary to be able to pivot the first drive shaft to different pivoting positions, for example by means of a lever or a motor drive.

It is particularly preferred that the housing comprises a tray extendable for use in a baking process, the tray supporting a dough pan holding the dough and preferably being exchangeable.

The tray, which is extendable from the housing, also allows for a compact structure of the baking device so that the same is suited for domestic use. The tray can be pulled out up to a predetermined stop position so that the dough pan holding the dough is automatically situated in the correct position for the dough roller.

The object is also achieved with the features of claim 4.

Preferably, it is provided that at least one of the pivot arms has drive means for driving the dough roller supported at the free end of the pivot arms. Using the drive means arranged at the pivot arms, the rotary movement can be transmitted to the dough roller without a drive motor being exposed to the heat in the baking chamber or to strongly varying temperatures.

Preferably, the drive means extend in or at the pivot arm. The drive means may be, for example, chain drives, toothed belt drives or bevel gear drives similar to a vertical shaft drive. When arranged inside the pivot arm or when the drive means are covered, these are also protected against heat and soiling.

The object is also achieved with the features of claim 7.

In this case, the pivot arms are arranged inside the baking chamber.

In a preferred embodiment, it is provided that the first drive shaft supported in the housing protrudes from the housing on at least one side thereof for the purpose of pivoting the dough roller, and that this shaft is connected for rotation with a pivot lever or a drive for the purpose of adjusting and locking the pivoting position of the dough roller. Using the pivot lever, various pivoting positions can be adjusted both in the dough take-up position and in the baking position. The pivot lever can be locked in different indexing positions. As an alternative, it is possible to maintain the dough roller in predetermined positions by means of the pivot lever and a brake arranged coaxially with respect to the drive shaft.

The heating apparatus preferably consists of a plurality of heating rods arranged in parallel with the dough roller, the heating rods preferably being arranged in the upper, rear and/or lower part of the baking chamber. These heating rods may be arranged in the baking chamber in an arc shape, seen in cross section, so that they are all spaced by a similar distance from the Baumkuchen building up. Instead of electric heating elements, such as quartz rods or heat pipes (resistance heating rods), for example, it is also possible to use a gas heating with an open flame or a heating by means of charcoal.

Preferably, at least the rear wall and/or the bottom wall of the housing are reflective. A rear wall and/or bottom surface reflecting in a mirror-like manner are particularly preferred.

The rotary speed of the dough roller can be adjusted in increments or in an infinitely variable manner. Preferably, a 12 Volt drive motor with an upstream regulating transformer is used.

The housing has double-walled exterior walls at least on the sides, which serve for insulating purposes. In a preferred embodiment, the outer walls of the double-walled exterior walls may be provided with ventilation slots.

Preferably, the housing comprises a swivel flap with a viewing window, the flap closing the baking chamber to the front. In another embodiment the swivel flap can be coupled with the first drive shaft in order to open or close the swivel flap, so that when the laterally arranged pivot lever is operated to pivot the dough roller outward, the swivel flap is opened simultaneously.

On at least one side of the housing, the motor and the transmission for the second drive shaft of the dough roller drive and/or the rotary speed control for the motor and/or the temperature control for the heating device can be arranged in the gap between a double-walled exterior wall.

The following is a detailed description of an embodiment of the invention with reference to the drawings.

In the Figures:

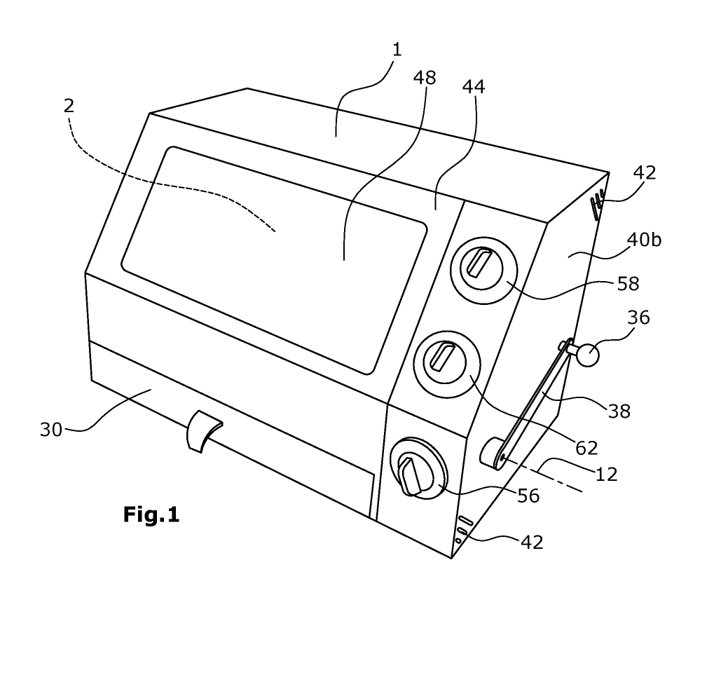

FIG. 1 shows a Baumkuchen baking device for domestic use,

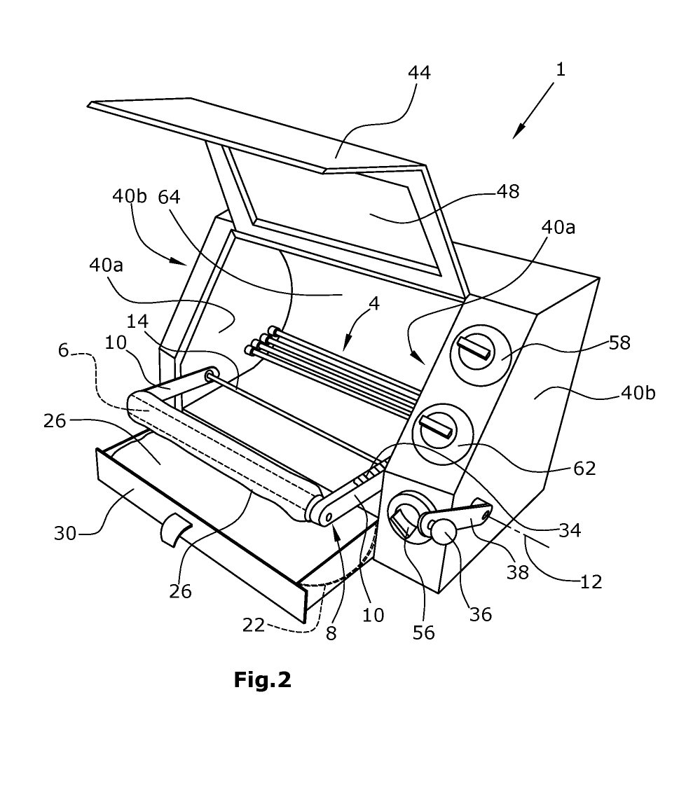

FIG. 2 shows the baking device with the swivel flap open and the tray pulled out,

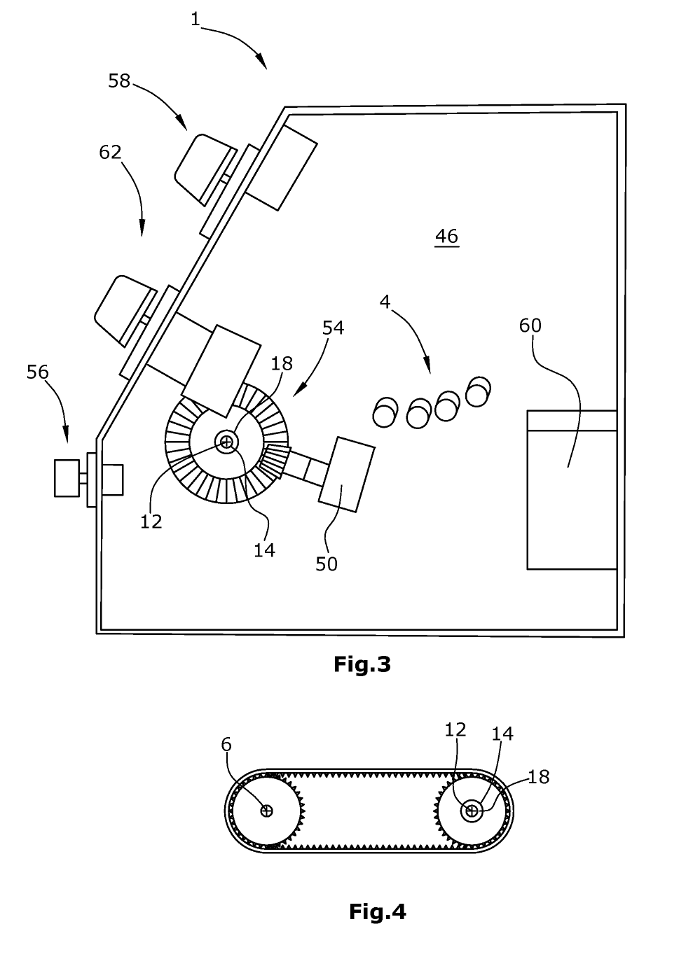

FIG. 3 is a side elevational view of the housing with the exterior wall removed, and

FIG. 4 illustrates the drive of the dough roller.

FIG. 1 is a perspective view of a Baumkuchen baking device for domestic use. The baking device has a housing 1 enclosing a baking chamber 2 that is accessible via a door, preferably a swivel flap 44, with a heat resistant viewing window 48. The viewing window 48 can comprise a double-glazed safety glass pane with an insulating layer of air circulating between the panes. In this regard, an open gap is provided between the panes, which is not sealed in an airtight manner.

In the baking chamber, a heating device 4 is arranged in the lower and rear region, which device may be formed for example by infrared heating elements, such as quartz rods, or by electric resistance heating rods.

As an alternative, it is possible to provide for heating by means of gas or coal. The heating device 4 can be set to different power levels and may additionally have a temperature control that allows a preset temperature level to be maintained.

A dough roller 6 for making Baumkuchen is adapted to be pivoted about a pivot axis 12 by means of a first drive shaft 14. The first drive shaft 14 is supported in the lateral exterior walls 40 of the housing, wherein two pivot arms 10 being connected to the ends of the first drive shaft 14 inside the baking chamber 2 in a manner fixed for rotation with the first drive shaft 14. At its free ends 8, the pivotable dough roller 6 is exchangeably and rotatably supported between the two pivot arms 10. In order to remove the Baumkuchen in its finished state from the dough roller 6, it is possible, preferably in a pivoted state in which the dough roller 6 projects outward from the housing 1, to decouple the dough roller 6 from their support in the pivot arms 10 by slightly spreading the pivot arms 10 or by means of a resilient axis element engaging into a pivot arm 10.

When the dough roller 6 is pivoted to the front, it is arranged above a dough pan 22, as best seen in FIG. 2. The dough pan 22 contains the dough 26 necessary for baking, the dough pan 22 being supported by a tray 30 adapted to be pulled out from the housing 1. As a consequence, the dough pan 22 can be removed from the tray 30 for cleaning or for replacement with another dough pan 22 with another kind of dough or coating 26.

When the baking device is not in use, the tray 30 with the dough pan 22 can be pushed into the housing 1 in a space saving manner.

On the side of the dough roller 6, i.e. the right side in FIG. 2, a drive means 34 is arranged in an exemplary manner in the support arm 10 for the purpose of driving the dough roller 6 supported at the free end 8 of the pivot arms 10. The drive means may also be integrated in the dough roller 6 or be set on the axis of the dough roller at a lateral end thereof.

The drive means 34 in FIG. 2 may be a chain drive or a belt drive or a bevel gear drive in the manner of a vertical shaft drive, for example, the drive means 34 preferably being encased for protection against heat and dirt (FIG. 4).

The pivot arm 10 provided with the drive means 34 has its free end 8 provided with, for example, a pinion for the chain drive, that is removably connected in a form-fitting manner with the dough roller 6, e.g. by a square connection. The first drive shaft 14 for pivoting the pivot arms 10 with the dough roller 6 also comprises a pinion for the chain drive, which pinion, for the purpose of rotationally driving the dough roller 6, is connected with a second drive shaft 18 for rotation therewith. The first drive shaft 14 and the second drive shaft 18 are supported coaxially with respect to the pivot axis 12 in a first lateral exterior wall 40a, the second drive shaft 18 being rotatably supported on the first drive shaft 14.

The second drive shaft 18 ends in an intermediate space 46 of the double-walled exterior wall 40 and is coupled there with a motor 50 through a bevel gear transmission 54, the motor preferably being infinitely variable or adjustable to three or four levels by means of a rotary speed control 56. For example, the motor 50 is a 12 Volt drive motor whose rotary speed can be adjusted by means of a variable transformer 60. Therefore, besides the bevel gear transmission 54, the intermediate space 46 also accommodates the motor 50, the transformer 60, the rotary speed control 56 and a thermostatic temperature control 58, as well as a switch 62 for setting different heating levels by activating all or only a number of the heating rods. The intermediates space 46 is covered by a second, outer exterior wall 40b which may be provided with ventilation slots 42 in its bottom and top ends.

The first drive shaft 14 for pivoting the pivot arms 10 with the dough roller 6 further passes beyond the intermediate space 46 through the outer exterior wall 40b and, outside the housing 1, the shaft is coupled for rotation with a pivot lever 38 for adjusting and locking different swivel positions of the dough roller 6. Using the pivot lever 38, which has a handling knob 36 at its free end, the dough roller 6 can be pivoted from a heating and baking position near the heating apparatus 4 to a dough take-up position above the dough pan 22, in which the dough roller 6 can dip into the dough 26 while rotating, with the tray 30 in the extended position.

The double-walled design of the exterior walls 40 serves to insulate the housing 1 so that the areas that might be touched will not reach temperature that could cause burns to people. The baking chamber 2 is preferably made from stainless steel or tinplate with a galvanized tin surface. The rear or bottom wall 64 facing the baking chamber 2 may be reflective, preferably mirroring, in order to reflect a maximum of heat radiation on the one hand and, on the other hand, to prevent the exterior walls of the housing 1 from being heated too much. By a special shaping, e.g. bevels or deep-drawn structures, the sheet metal members and walls can be designed to be stable. Further, dripped-down, baked dough can be removed very well from a mirror surface.

The operating elements for the rotary speed control 56, the temperature control 58 and the selection of the heating power 62 (not ultimately necessary) are arranged on the front side of the housing 1.

For making a Baumkuchen, after having opened the preferably pivotable swivel flap 44, the tray 30 is pulled out first and dough 26 is filled into the dough pan 22. Thereafter, the dough roller 6 is moved to a heating position near the heating device 4, where it is heated to a preset baking temperature. After the dough roller 6 has been heated up, fat is applied thereon, e.g. by means of a brush, and the roller is pivoted frontward to a dough take-up position above the dough pan 22 by means of the pivot lever 38. Preferably, the dough roller 6 can also be wrapped with aluminum foil or baking paper thus allowing an easier withdrawal of the finished baked Baumkuchen. In this position, the dough roller 6 can dip into the dough 26 while rotating or the dough 26 can be applied onto the rotating dough roller 6, e.g. by means of a ladle. Thereafter, the dough roller 6 with the dough 26 applied thereon is pivoted to a baking position near the heating device 4 and a first baking process is performed with the dough roller 6 rotating. After the first baking process has been finished, the previous steps of applying the dough 26 and baking are repeated until a Baumkuchen with a plurality of layers is finished.

Further, an automated embodiment may be provided, wherein a motor drive is provided instead of the pivot lever, which drive performs the pivoting for taking up dough in an automatic time-controlled manner through stop sensors and/or angle sensors. The dough pan can contain the full quantity of dough necessary for the baking process.

When the Baumkuchen has cooled down, it can be removed from its support between the pivot arms 10 in the front pivot position, in order to take the finished Baumkuchen from the dough roller 6.

1-15. (canceled)

16. A baking device for Baumkuchen for domestic use, comprising a housing that encloses a baking chamber, a heating apparatus in the baking chamber, a dough roller that is pivotable relative to the heating apparatus in the baking chamber, which dough roller is supported in a replaceable manner between free ends of two pivot arms so as to be pivotable about a pivot axis supported in the housing for the pivot arms, the pivot axis being configured as a first drive shaft to pivot the dough roller, with the dough roller being arranged to be rotationally driven by a second drive shaft,
wherein,
on at least one side of the housing, the second drive shaft is supported coaxially with respect to the pivot axis.

17. The device of claim 16, wherein the housing comprises an integrated dough holding dough pan, and the dough roller is arranged to be pivoted from a heating and baking position near the heating device to a dough take-up position above the dough holding dough pan.

18. The device of claim 16, wherein the housing has a tray which is extendable for operation and supports the dough holding dough pan.

19. A baking device for Baumkuchen for domestic use, comprising a housing that encloses a baking chamber, a heating apparatus in the baking chamber, a dough roller that is pivotable relative to the heating apparatus in the baking chamber, which dough roller is supported in a replaceable manner between free ends of two pivot arms and is pivotable about a pivot axis supported in the housing for the pivot arms, the pivot axis being configured as a first drive shaft for pivoting the dough roller and the dough roller being arranged to be rotationally driven by a second drive shaft,
wherein,
the housing has a tray which is extendable for operation and supports a dough holding dough pan, and
the dough roller is arranged to be pivoted from a heating and baking position near the heating device to a dough take-up position above the dough pan, wherein at said dough take-up position, the dough roller will dip into any rotating dough.

20. The device of claim 19, wherein on at least one side of the housing, a second drive shaft arranged to rotationally drive the dough roller is supported coaxially with respect to the pivot axis.

21. The device of claim 16, wherein at least one of the pivot arms has a drive arranged to drive the dough roller supported at free ends of the pivot arms.

22. A baking device for Baumkuchen for domestic use, comprising: a housing that encloses a baking chamber, a heating apparatus in the baking chamber, a dough roller that is pivotable relative to the heating apparatus in the baking chamber, which dough roller is supported in a replaceable manner between free ends of two pivot arms that are pivotable about a pivot axis supported in the housing for the pivot arms, the pivot axis being configured as a first drive shaft that pivots the dough roller and the dough roller being arranged to be rotationally driven by a second drive shaft,
wherein,
the pivot arms are arranged within the baking chamber.

23. The device of claim 22, wherein the housing has a tray which is extendable for operation and supports a dough holding dough pan, and
the dough roller is arranged to be pivoted from a heating and baking position near the heating device to a dough take-up position above the dough holding dough pan, wherein at said dough take-up position the dough roller will dip into any rotating dough.

24. The device of claim 22, wherein the dough roller has an integrated drive motor.

25. The device of claim 16, wherein the pivot arms are arranged within the baking chamber.

26. The device of claim 16, wherein, for the purpose of pivoting the dough roller, the first drive shaft supported in the housing protrudes from at least one side of the housing and is connected for rotation with a pivot lever or a drive arranged to set and lock a swivel position of the dough roller.

27. The device of claim 16, wherein the heating apparatus is formed by a plurality of heating rods arranged in parallel with the dough roller, which rods are arranged in the rear of the baking chamber.

28. The device of claim 16, wherein a rear or bottom wall of the housing facing the baking chamber is reflective.

29. The device of claim 16, wherein the housing has a swivel flap with a viewing window, the flap closing the baking chamber to the front.

30. The device of claim 29, wherein the swivel flap is coupled with the first drive shaft to enable opening and closing the swivel flap.

31. The device of claim 27, wherein the rods are arranged in an arcuate configuration as viewed in a direction parallel to the dough roller.

32. The device of claim 28, wherein the rear or bottom wall is mirrored.
